(19) United States
(12) Patent Application Publication
(10) Pub. No.: US 2007/0055614 A1
(43) Pub. Date: Mar. 8, 2007

(54) Management of orders not accepted by the stock market at the level of an order server

(75) Inventor: Elric Auribault, Paris (FR)

Correspondence Address: IP GROUP OF DLA PIPER US LLP, ONE LIBERTY PLACE, 1650 MARKET ST, SUITE 4900, PHILADELPHIA, PA, 19103, US

(73) Assignee: GL Trade, a corporation of France, Paris (FR)

(21) Appl. No.: 11/508,490

(22) Filed: Aug. 23, 2006

(30) Foreign Application Priority Data
Aug. 31, 2005 (FR) 05/08915

(51) Int. Cl. G06Q 40/00

(52) U.S. Cl. 705/37

(57) ABSTRACT

A process for putting orders through from a client station to a stock market with an order server and to an application for order management connected to the order server, which application for order management is suitable for handling a set of rules associated with orders, including sending to the order server an order and a rule associated with the order for the client station, sending the order and the rule associated with the order in a selective manner to the application for order management, applying the rule to the application for order management, sending back a result from the application of the rule to the order server, and sending the result to the stock market by way of the order server.

### RELATED APPLICATION

This application claims priority of French Patent Application No. 05/08915, filed Aug. 31, 2005, herein incorporated by reference.

### TECHNICAL FIELD

This disclosure relates to methods for putting orders through to a stock market.

### BACKGROUND

In known architectures such as the one illustrated in FIG. 1, when a client 3 gives orders to a stock market institution 1, the order is at least archived and routed to the stock market at the level of a server for putting through orders and/or content 2.

It is also known that orders can be put through according to certain rules. A known example of such a rule is an order called “STOP.” A “STOP” order is an order for which the user specifies a trigger price level. That is to say, this order will only be sent to the market when the price level has been attained, offered or requested in the market.

However, the stock markets do not accept all these conditions on orders and it is sometimes impossible to generate specific rules while being sure that they will be handled by the stock market. Furthermore, certain types of orders are interesting for traders and are not supported by any stock market.

It could therefore be advantageous to provide a means to traders for putting orders through to a stock market according to a certain mode or rule even if the stock market does not accept the handling of these rules.

### SUMMARY

This invention relates to a process for putting orders through from a client station to a stock market with an order server to an application for order management connected to the order server, which application for order management is suitable for handling a set of rules associated with orders, including sending to the order server an order and a rule associated with the order for the client station, sending the order and the rule associated with the order in a selective manner to the application for order management, applying the rule to the application for order management, sending back a result from the application of the rule to the order server, and sending the result to the stock market by way of the order server.

### BRIEF DESCRIPTION OF THE DRAWINGS

The disclosure will be better understood with the aid of the description, given below purely by way of explanation, of selected, representative examples with reference made to the attached figures in which:

FIG. 1 illustrates an example of placing orders known in accordance with the prior art;

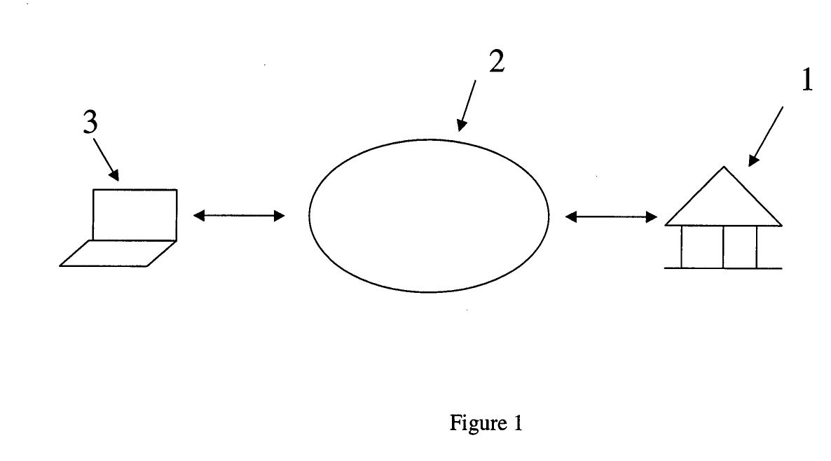

FIG. 2 illustrates an example of architecture of placing orders simulating the managing of orders and of rules; and

FIG. 3 is an example of an implemented process.

### DETAILED DESCRIPTION

I provide processes for putting orders through from a client station 3 to a stock market 4 with the aid of an order server 2 connected to a stock market 1 and to an application 4 for order management connected to the order server 2, which application for order management 4 is suitable for handling a set of rules associated with orders. The processes comprise:
sending to order server 2 an order as well as a rule associated with the order for client station 3,
sending the order as well as the rule associated with the order in a selective manner to the level of application 4 for order management,
applying the rule to the order for application 4 for order management,
sending back the result of application of the rule to the level of order server 2, and
sending the result to stock market 1 for order server 2.

To render the process transparent for the user and so that the user can put orders through provided with rules to any type of stock market, the processes may furthermore comprise
a previous stage of informing at the level of the order server the set of rules about the orders supported by the stock market, and for the application for order management, informing at the level of the order server the set of rules about the orders supported by it, and selective sending of the order as well as the rule associated with the order at the level of the application for order management is realized only if the rule associated with the order is not supported by the stock market, but is by the application for order management.

The selective sending of the order as well as the rule associated with the order at the level of the application for order management may be a function of a parameter generated at the level of the client station specifying whether the order as well as the rule associated with the order should be sent to the application for order management or directly to the stock market. This possibility is only offered to the user in the instance in which the rule that is desired to be applied to the order is supported both by the stock market and by the application for order management.

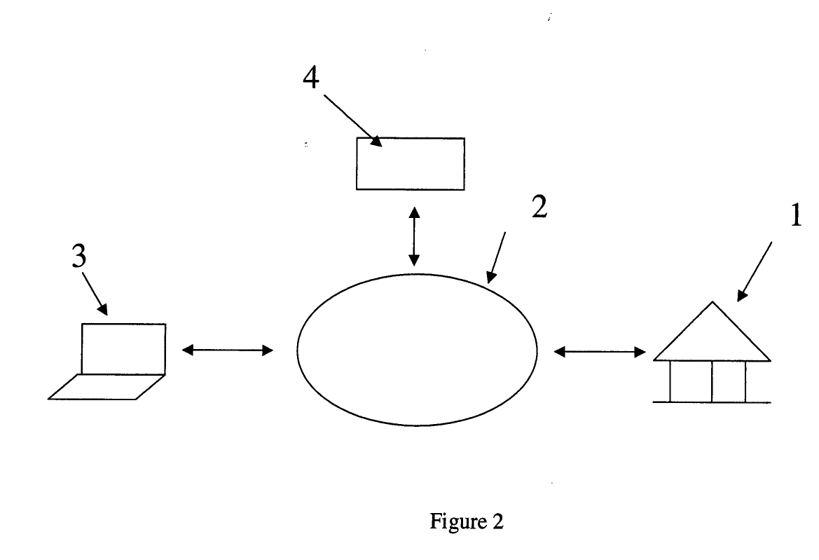

FIG. 2 illustrates a representative architecture that comprises client station 3 connected to stock market 1 via order and/or content server 2, and application for order management 4 connected to order and/or content server 2.

It is understood that server 2 is an order server that is capable of receiving orders of clients, archiving them and transmitting them to the stock market. It is also capable of receiving receipts or rejections from stock market 1 and of re-transmitting this information to client station 3.

It can also comprise the functions of content server by receiving public data issued by the stock market.

Therefore, server 2 comprises one or several handling and archiving units capable of managing the orders and/or the public content.

The term “stock market” designates any type of stock market capable of transmitting stock market data to clients of the market.

A set of rules for handling orders is implemented in application for order management 4, a processor or the like. The advantage of this implementation resides in the fact that these rules are not necessarily supported by the stock market receiving the order or by any stock market in the market.

Several types of rules associated with orders that can be handled by application 4 are described here.

According to a first example, an order is only executed under certain conditions as a function of the content issued by the stock market. In that instance, the rules are sent to the level of application 4, that also receives the data of the stock market, possibly via a content server integrated or non-integrated in server 2.

The application for order management then applies the rule as a function of the data received by triggering the order according to the content. In that instance, the order is transmitted to order server 2, that routes it to stock market 1.

An example of such an order strategy is, e.g., an order called “STOP,” for which it is expected that a certain price level is quoted, offered or asked on the market for sending it to the market.

A second type of rule corresponds to a modification of the order in the course of time. In that instance, the order is sent directly to the market, but it can be modified automatically as a function of the development of the market. For an order “PEG,” for example, the price limit of the order is automatically adjusted as a function of a reference price. That is, each time that the price serving as reference develops, the limit price of the order “PEG” is modified in a proportional manner.

In some circumstances, only private data contained in the order server is used for applying rules. An example of such a tactic for putting an order through is the order “ICEBERG” in which an order for a certain quantity is cut automatically into a plurality of orders by application 4.

According to that situation, application 4 first detects an order type “ICEBERG” and cuts the order according to a plurality of determined sub-quantities. Upon receipt of the different sub-quantities received by order server 2, application for order management 4 then initiates sending of the following sub-quantity.

It will be understood in that instance that the application for order management only takes data of the order server as parameters without requiring information from a flow server representing the public data of the market.

The functionalities of the application for order management may be implemented in a manner transparent for the user who, when passing through an order associated with the rules, does not know if the latter have been applied directly by stock market 1 or by application for order management 4. In order to do this, the set of rules for the orders supported by the stock market is entered at the level of order server 2. The set of rules supported by application for order management 4 is also stored.

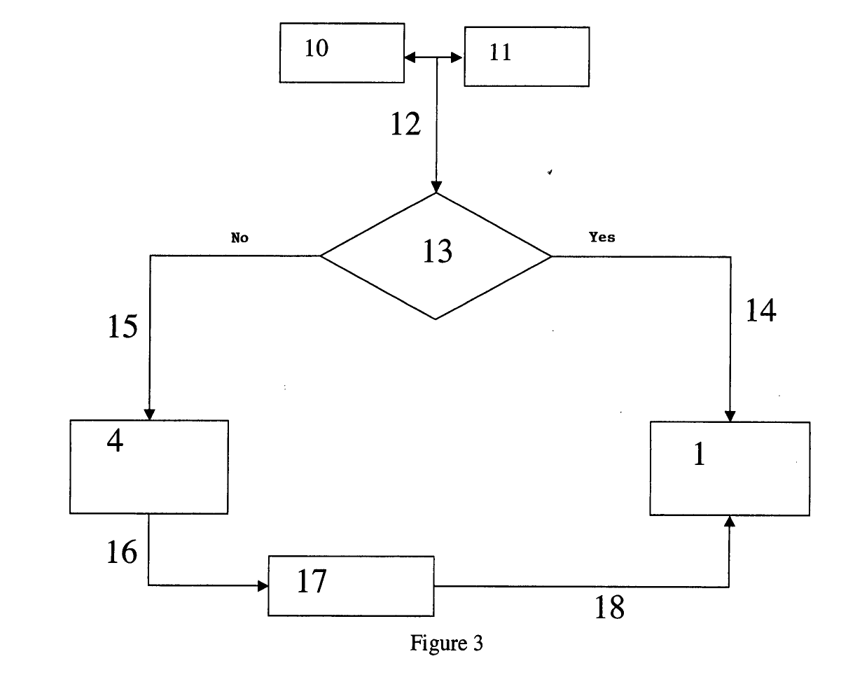

FIG. 3 schematically illustrates when an order 10 provided with rules 11 arrives 12 at server 2, which tests 13 whether these rules are supported or not supported by the stock market. If the rules are supported by the stock market, the order and the rules are transmitted directly 14 to it for execution. If the rules are not supported by the stock market, server 2 tests whether they are supported by application for order management 4. If this is not the case, an error notification is sent back to the client station. If the rules are supported by application 4, server 2 sends 15 the order as well as the rules to application 4 which applies the rules to the order, possibly as a function of content received from the stock market, and sends 16 the result of the application of rules 17 back to order server 4.

The latter then transmits 18 the order result to the stock market for execution.

The user may specify at the level of the client station whether the user desires to use or not use application for order management 4 or pass the order directly through via the stock

This is implemented, e.g., by an interface at the level of the software for putting orders through of the client station of the type:
“Would you like to use an application for order management?”

The user interface can propose, e.g., different order strategies supported by application for order management 4 as well as the different parameters associated with the strategy selected. One skilled in the art can implement such an interface as a function of strategies and rules supported by application for order management 4.

The use of application 4 is advantageous because it is very adaptive and because the needs of the traders, the rules or the order strategies can be implemented without being confined by the handling limitations of the stock market.

1. A process for putting orders through from a client station to a stock market with an order server and to an application for order management connected to the order server, which application for order management is suitable for handling a set of rules associated with orders, comprising:
sending to the order server an order and a rule associated with the order for the client station,
sending the order and the rule associated with the order in a selective manner to the application for order management,
applying the rule to the application for order management,
sending back a result from the application of the rule to the order server, and
sending the result to the stock market by way of the order server.

2. The process according to claim 1, further comprising a previous stage of informing at the level of the order server a set of rules about the orders supported by the stock market, and for application for order management, informing at the level of the order server the set of rules about the orders supported by it, and the selective sending of the order and the rule associated with the order at the level of the application for order management is realized only if the rule associated with the order is not supported by the stock market, but is by the application for order management.

3. The process according to claim 1, wherein the selective sending of the order and the rule associated with the order at the level of the application for order management is a function of a parameter generated at the level of the client station specifying whether the order as well as the rule associated with the order should be sent to the application for order management or directly to the stock market.

4. The process according to claim 1, wherein the selective sending of the order and the rule associated with the order at the level of the application for order management is a function of the public content of the market at the level of the stock market.

5. The process according to claim 1, wherein the selective sending of the order and the rule associated with the order at the level of the application for order management is a function of the state of the orders at the level of the order server.

6. A process for putting orders through from a client station to a stock market comprising:
sending to an order server an order and a rule associated with the order from the client station;
sending the order and the rule associated with the order in a selective manner to a processor for order management;
applying the rule in the processor for order management and generating a result,
sending the result to the order server; and
sending the result to the stock market from the order server.
